(19) United States
(12) Patent Application Publication
(10) Pub. No.: US 2026/0270688 A1
(43) Pub. Date: Sep. 10, 2026

(54) CALLING METHOD AND APPARATUS FOR COMPUTING POWER SERVICE, AND STORAGE MEDIUM

(71) Applicant: BEIJING XIAOMI MOBILE SOFTWARE CO., LTD., Beijing (CN)

(72) Inventors: Dong CHEN, Beijing (CN); Zhibin HE, Beijing (CN)

(21) Appl. No.: 19/165,970

(22) PCT Filed: Mar. 17, 2023
(86) PCT No.: PCT/CN2023/082299

§ 371 Date: Sep. 16, 2025

(51) Int. Cl. H04W 8/24; H04W 4/50

(52) U.S. Cl. CPC H04W 8/245; H04W 4/50

(57) ABSTRACT

A method for calling a calculation capability service in a wireless communication network includes: receiving a service request sent by a first UE, in which, the service request requests to call a calculation capability service; and sending indication information of performing the calculation capability service to at least one third UE, in which, the at least one third UE is a UE that meets a requirement corresponding to the calculation service.

### CROSS REFERENCE TO RELATED APPLICATIONS

This application is a US national phase application based on International Application No. PCT/CN2023/082299, filed on Mar. 17, 2023, the entire content of which is incorporated by reference.

### TECHNICAL FIELD

The present disclosure relates to the field of wireless communication technologies, and particularly to a method and an apparatus for calling a calculation capability service and a storage medium.

### BACKGROUND

In future network systems, user equipments (UEs), or terminals, can provide calculation capabilities to a network. Terminals may achieve flexible and direct communication through service-based interfaces. Massive terminals may register and store their calculation capabilities in the network and perform distributed calculation collaborative with the network, which may reduce a task pressure carried by the network and improve a resource utilization efficiency of terminals in an idle state.

### SUMMARY

According to a first aspect, an embodiment of the present disclosure provides a method for calling a calculation capability service. The method is performed by a network device and includes: receiving a service request sent by a first user equipment (UE), in which, the service request is used to request to call a calculation capability service; and sending indication information of performing the calculation capability service to at least one third UE, in which, the at least one third UE is a UE that meets a requirement corresponding to the calculation service.

According to a second aspect, an embodiment of the present disclosure provides a method for calling a calculation capability service. The method is performed by a network device and includes: receiving a service request sent by a first user equipment (UE), in which, the service request requests to call a calculation capability service; determining, based on the service request and calculation capability registration information of at least one second UE, at least one third UE among the at least one second UE; and determining presence or absence of the at least one third UE, in which, the at least one third UE is a UE that meets a requirement corresponding to the calculation service.

According to a third aspect, an embodiment of the present disclosure provides a method for calling a calculation capability service. The method is performed by a first network element and includes: sending calculation capability registration information of at least one second user equipment (UE) to a calculation service module; in which, the calculation capability registration information of the at least one second UE is used to assist the calculation service module in determining at least one third UE that performs a calculation capability service.

### BRIEF DESCRIPTION OF THE DRAWINGS

The above-mentioned and/or additional aspects and advantages of the present disclosure may be apparent and readily understood from the following description of embodiments taken in combination with the accompanying drawings, in which:

FIG. 1 is a schematic diagram illustrating an architecture of a communication system provided in an embodiment of the present disclosure.

FIG. 2 is a flowchart illustrating a method for calling a calculation capability service according to an embodiment of the present disclosure.

FIG. 3 is a flowchart illustrating a method for calling a calculation capability service according to an embodiment of the present disclosure.

FIG. 4 is a flowchart illustrating a method for calling a calculation capability service according to an embodiment of the present disclosure.

FIG. 5 is a flowchart illustrating a method for calling a calculation capability service according to an embodiment of the present disclosure.

FIG. 6 is a flowchart illustrating a method for calling a calculation capability service according to an embodiment of the present disclosure.

FIG. 7 is a flowchart illustrating a method for calling a calculation capability service according to an embodiment of the present disclosure.

FIG. 8 is a flowchart illustrating a method for calling a calculation capability service according to an embodiment of the present disclosure.

FIG. 9 is a flowchart illustrating a method for calling a calculation capability service according to an embodiment of the present disclosure.

FIG. 10 is a flowchart illustrating a method for calling a calculation capability service according to an embodiment of the present disclosure.

FIG. 11 is a flowchart illustrating an interactive method for calling a calculation capability service according to an embodiment of the present disclosure.

FIG. 12 is a flowchart illustrating an interactive method for calling a calculation capability service according to an embodiment of the present disclosure.

FIG. 13 is a schematic diagram illustrating a structure of a calculation service module according to an embodiment of the present disclosure.

FIG. 14 is a schematic diagram illustrating a structure of a calculation service module according to an embodiment of the present disclosure.

FIG. 15 is a schematic diagram illustrating a structure of a first UE according to an embodiment of the present disclosure.

FIG. 16 is a schematic diagram illustrating a structure of a third UE according to an embodiment of the present disclosure.

FIG. 17 is a schematic diagram illustrating a structure of a third UE according to an embodiment of the present disclosure.

FIG. 18 is a schematic diagram illustrating a structure of a first network element according to an embodiment of the present disclosure.

FIG. 19 is a schematic diagram illustrating a structure of a first network element according to an embodiment of the present disclosure.

FIG. 20 is a schematic diagram illustrating a structure of a communication device according to an embodiment of the present disclosure.

FIG. 21 is a schematic diagram illustrating a structure of a communication device as a chip or a chip system according to an embodiment of the present disclosure.

FIG. 22 is a schematic diagram illustrating a structure of a communication system according to an embodiment of the present disclosure.

### DETAILED DESCRIPTION

Embodiments will be described in detail herein, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with embodiments of the disclosure. Instead, they are merely examples of apparatuses and methods consistent with aspects related to the disclosure as recited in the appended claims.

The terms used in embodiments of the present disclosure are only for the purpose of describing specific embodiments, and are not intended to limit embodiments of the present disclosure. The singular forms “a” and “the” used in embodiments of the present disclosure and the appended claims are also intended to include plural forms unless the context clearly indicates otherwise. It is also understood that the term “and/or” as used herein refers to and includes any and all possible combinations of one or more of associated listed items.

It should be understood that, although the terms first, second, third, etc. may be used in embodiments of the present disclosure to describe various information, such information shall not be limited to these terms. These terms are only used to distinguish the same category of information. For example, subject to the scope of embodiments of the present disclosure, first information may also be referred to as second information, and similarly, second information may also be referred to as first information. It depends on the context. For example, the word “if” or “in case of” as used herein may be interpreted as “upon” or “when” or “in response to determining”.

Reference will be made in detail to embodiments of the present disclosure. Examples of the embodiments of the present disclosure will be shown in drawings, in which the same or similar elements are denoted by like reference numerals throughout the descriptions. The following embodiments described according to the accompanying drawings are illustrative and intended to explain the present disclosure, not construed to limit the present disclosure.

To facilitate understanding, terms involved in the disclosure are introduced first.

### 1. Access and Mobility Management Function (AMF) Network Element

The AMF network element supports a terminal with different mobility management requirements, and may perform the following major tasks: non-access stratum (NAS) signaling termination; NAS signaling security; access stratum security control; core network node-to-node signaling for mobility between 3GPP access networks; reachability of a terminal in an idle mode (including control and execution of paging retransmissions); registration region management; support for intra-system and inter-system mobility; access authentication; access authorization, including roaming authorization check; mobility management control (subscription and policy); support for network slicing; session management function (SMF) selection.

### 2. Session Management Function (SMF) Network Element

The SMF network element may support a customized mobility management scheme together with the AMF, such as “mobile initiated connection only” (MICO) or an RAN enhancement function, like a “RRC Inactive” state. The SMF network element may perform the following major tasks: session management; terminal IP address allocation and management; user plane function (UPF) selection and control; configuration of traffic control in UPF to route traffic to an appropriate destination; policy enforcement and quality of service (QoS) control portion; downlink data notification.

### 3. Unified Data Management (UDM) Network Element

The UDM is used for management of user identification, subscription data, authentication data, and user service network element registration management.

The various network elements/functions involved in embodiments of the present disclosure may be an independent hardware device or a function implemented by computer codes in the hardware device, which is not limited in embodiments of the present disclosure.

### 4. Network Exposure Function (NEF) Network Element

The NEF is a network function that 5GC exposes to outside and provides a standard interface. Based on 3GPP network functions, the NEF exposes functions and events to other systems, providing both exposure and system security. Existence of the NEF standardizes a display of 5GC functions and facilitates third-party access.

### 5. Application Function (AF) Network Element

The AF is similar to an application server, which interacts with other 5G core network control plane NFs and provides service services. The AF may exist for different application services and may be owned by operators or trusted third parties.

### 6. Authentication Server Function (AUSF) Network Element

The AUSF is a network element that supports a unified authentication service function in 5G, realizes 3GPP and non-3GPP access authorization, and is a network entity in a 5G core network (5GC).

### 7. Policy Control Function (PCF) Network Element

The PCF supports a unified policy framework to manage network behavior, provides a policy rule to a network entity for implementation, and accesses subscription information in a unified data repository (UDR).

### 8. Unified Data Repository (UDR) Network Element

The UDR is used by the UDM to store subscription data or read subscription data and used by the UDM the PCF to store policy data or read policy data.

### 9. Network Repository Function (NRF) Network Element

The NRF supports a service discovery function, receives a NF discovery request from a NF instance, and provides (discovered) information of discovered NF instance to the NF instance, while maintaining available NF instances and NF profiles of their supported services.

### 10. User Plane Function (UPF) Network Element.

The UPF is an interconnection point between a mobile infrastructure (e.g., RAN) and a data network (DN), completing encapsulation and decapsulation of a GTP-U (GRPS Tunneling) protocol on an UP. Typically, the UPF is used for a protocol data unit (PDU) session anchor point (Session Anchor Point) of intra-radio access technology (RAT) or inter-RAT mobility, including sending one or more end marker packets (EMP) to a gNB (NG-RAN node).

In order to better understand the solution in embodiments of the present disclosure, a communication system to which an embodiment of the present disclosure is applicable is first described below.

A 6G (sixth generation mobile communication system) service-oriented architecture abstracts functions of network elements into a plurality of services. Compared with a traditional network architecture, the 6G service-oriented architecture introduces integrated sensing and communication to provide terminals with a variety of services (such as sensing services, calculation capability services, artificial intelligence (AI) services, etc.). The 6G service-oriented architecture includes network elements for providing services. Other network elements in the 6G service-oriented architecture achieve deep integration and mutual enhancement of multi-dimensional sensing, collaborative communication, and intelligent calculation functions through collaboration and sharing with the network elements providing services, enabling the network to have capabilities of intelligent interaction and processing of new information flows and wide-area intelligent collaboration.

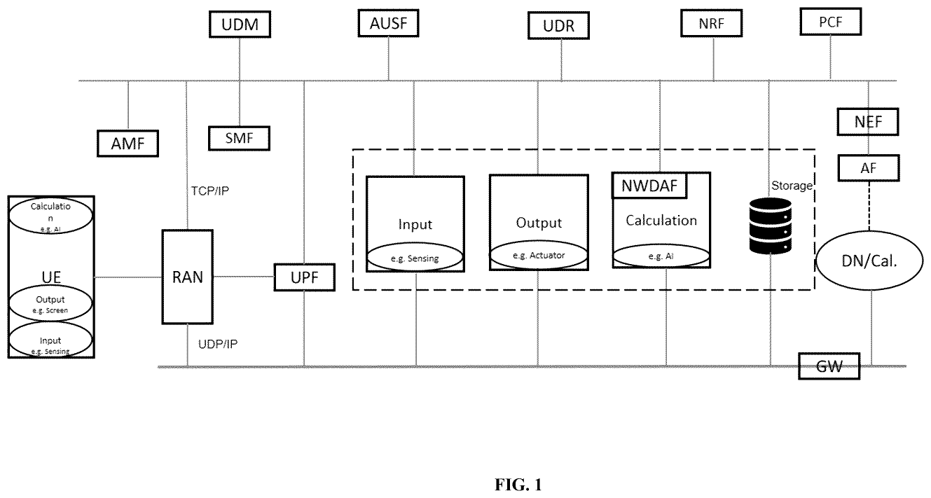

Reference is made to FIG. 1, which is a schematic diagram illustrating a 6G service-oriented network architecture provided by an embodiment of the present disclosure. FIG. 1 includes network elements in the 6G service-oriented network architecture and interfaces for communication between the network elements. As illustrated in FIG. 1, a dashed box represents a network element that provides a service. As illustrated in FIG. 1, the network element may realize capabilities such as sensing, AI calculation, and also has a storage capability.

A radio access network (RAN) illustrated in FIG. 1 may be an entity on a network side for transmitting or receiving signals. For example, the RAN may be an evolved NodeB (eNB), a transmission reception point (TRP), a next generation NodeB (gNB) in a NR system, a base station in other future mobile communication systems, or an access node in a wireless fidelity (Wi-Fi) system. The specific technology and specific device form adopted by the network device are not limited in the embodiments of the disclosure. The network device according to the embodiments of the disclosure may be composed of a central unit (CU) and distributed units (DUs). The CU may also be referred to as a control unit. The use of CU-DU structure allows to divide a protocol layer of the network device, such as a base station, such that some of the protocol layer functions are placed in the CU for centralized control, and some or all of the remaining protocol layer functions are distributed in the DUs, and the DUs are centrally controlled by the CU.

The user equipment (UE) (or referred to as terminal) illustrated in FIG. 1 may be an entity on a user side for receiving or transmitting signals, such as a cellular phone. The terminal may also be referred to as a terminal device, a user equipment (UE), a mobile station (MS), a mobile terminal (MT), and the like. The terminal can be a car with communication functions, a smart car, a mobile phone, a wearable device, a Pad, a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific device form adopted by the terminal are not limited in the embodiments of the disclosure.

In addition, FIG. 1 also includes network elements such as an AMF, a SMF, and a UDM. Based on collaborative scheduling of the AMF network element and the SMF network element, the terminal (i.e., the UE in FIG. 1) may establish a user plane connection with a network element providing a service through an RAN, such that the network element providing the service can provide the terminal with a service requested and called by the terminal. For a specific process of this part, reference can be made to subsequent embodiments.

It is understandable that the communication system described in embodiments of the disclosure is intended to clearly illustrate the technical solutions according to the embodiments of the disclosure, and does not constitute a limitation on the technical solutions according to the embodiments of the disclosure. It is understandable by those skilled in the art that as system architectures evolve and new business scenarios emerge, the technical solutions according to the embodiments of the disclosure are also applicable to similar technical problems.

A method and an apparatus for calling a calculation capability service, a device and a storage medium provided by embodiments of the present disclosure may be introduced in detail below with reference to the accompanying drawings. The method may be applied to a fifth (5G) generation mobile communication technology and its subsequent communication technology, such as a fifth generation mobile communication technology evolution (5G-advanced), a sixth generation (6G) mobile communication technology, etc., which are not limited in the present disclosure.

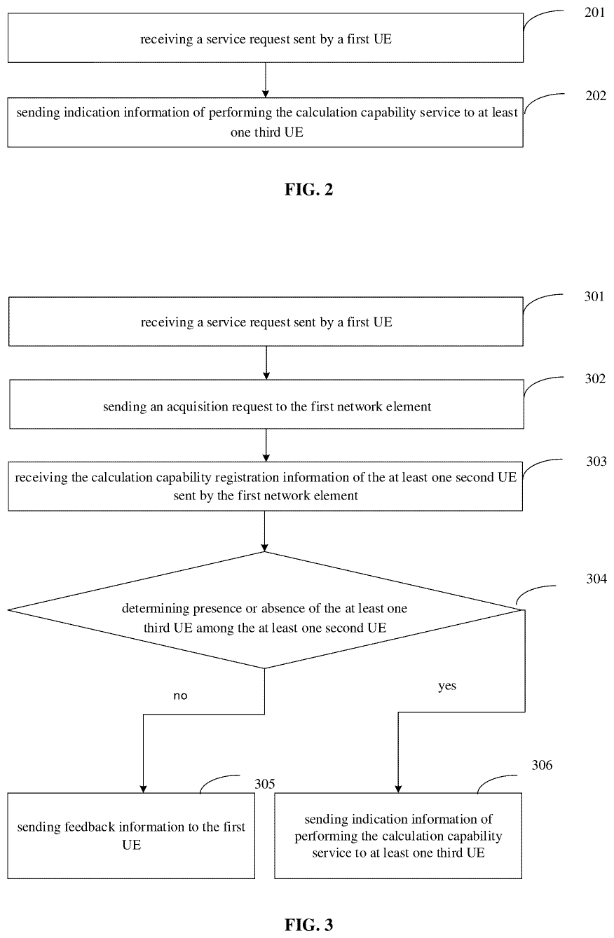

FIG. 2 is a flowchart illustrating a method for calling a calculation capability service according to an embodiment of the present disclosure. The method is performed by a calculation service module, and the calculation service module is deployed in a core network. In the present disclosure, the calculation service module may be deployed in the core network in a form of a network element device for overall scheduling and deployment of calculation capabilities, and its specific presentation form is not limited in the present disclosure.

It should be understood that the method for calling a calculation capability service provided in the present disclosure may be established under the following premises:
1. A user plane connection has been established between a UE (referred to as a first UE in this disclosure) and a core network;
2. A plurality of UEs (referred to as second UEs in this disclosure) that can provide calculation capability support for the core network have performed calculation capability registration with a calculation capability storage network element (referred to as the first network element in this disclosure) in the core network. After deployment of the calculation service module in the core network, all or part of the second UEs (referred to as third UEs in this disclosure) may receive a calculation capability task allocated from the core network.

As illustrated in FIG. 2, a method for calling a calculation capability service may include the following steps.

At step 201, a service request sent by a first UE is received.

In some embodiments of the present disclosure, the service request is used to request to call a calculation capability service.

In some embodiments of the present disclosure, the service request includes at least one of: an identifier of the first UE; an identifier of the calculation capability service; a type of the calculation capability service; a calculation capability requirement; or a network bandwidth.

In some embodiments of the present disclosure, the first UE may send the service request in a case of requiring the calculation capability service. For example, the first UE requires to perform image processing, and may trigger a request to the core network to call a calculation capability service for image processing.

In some optional embodiments of the present disclosure, an identifier of a UE may be a subscription permanent identifier (SUPI), or other identifiers that can uniquely identify the UE, which is not limited in the present disclosure. An identifier of the calculation capability (Cal Service ID) may be a code that marks a calculation capability service that can be called. A type of the calculation capability service (Cal Service Type) may be a code or a field that marks the type of the calculation capability service that can be called. The calculation capability requirement is a size of a calculation capability requirement of the UE for a current calculation task to be performed. The network bandwidth may be a downlink network bandwidth, such that the network device returns a data packet of a calculation result that meets the bandwidth requirement to the UE.

In the present disclosure, the calculation service module may receive the service request sent by the first UE through the user plane connection. The user plane connection between the first UE and the core network may be established in the following manner. In a case where the SMF network element receives a service calling request, it means that the terminal currently requests to call the service. The SMF network element may establish a connection with the first network element (an network element that provides a service requested by the terminal), such that the SMF network element subsequently interacts with the first network element to establish the user plane connection between the first network element and the terminal, thereby enabling the first network element to communicate with the terminal through the user plane to provide the terminal with the service requested by the terminal. It should be understood that the present disclosure does not limit the method for establishing the user plane connection, and user plane connections established in other possible manner all fall within the scope of the present disclosure. The service request is sent through the user plane connection to call the calculation capability service, without a need for a signaling interaction procedure through a control plane connection, and communication efficiency may be improved.

In the present disclosure, the calculation service module may also receive the service request sent by the first UE through other connections, which is not limited in the present disclosure.

At step 202, indication information of performing the calculation capability service is sent to at least one third UE.

In some embodiments of the present disclosure, the indication information may be information that instruct the third UE to perform the calculation service.

In some embodiments of the present disclosure, the indication information includes data information and/or a task requirement required to perform the calculation capability service.

The calculation service module may send the calculation task requested by the first UE as a whole to a third UE to perform the calculation service.

In some embodiments of the present disclosure, depending on different types of service requests, the calculation service module may also divide a calculation service requested by the UE into one or more sub-services, that is, to split a distributed calculation service, send the indication information to at least one determined third UE based on the divided sub-services, and allocate a plurality of sub-services to one or more third UEs for calculation. A calculation capability that the third UE can provide is greater than and similar to a calculation capability required for the sub-service, and a total calculation capability of a plurality of third UEs may be greater than or equal to a calculation capability requirement of a calculation task requested by the first UE, so as to provide the first UE with a reasonable calculation capability service for the service. Therefore, waste of calculation capability resources may be avoided.

In summary, according to the method for calling the calculation capability service provided by the present disclosure, the method is performed by the calculation service module, and the calculation service module is deployed in the core network. The method includes receiving the service request sent by the first UE, in which, the service request is used to request to call the calculation capability service; and sending indication information of performing the calculation capability service to the at least one third UE, in which, the at least one third UE is the UE that meets the requirement corresponding to the calculation service. The solution of the present disclosure realizes that the UE to provides the calculation capability service cooperative with the network. With registering and storing the calculation capability of the UE in the network, the UE may perform distributed calculation collaborative with the network, which reduces a task pressure carried by the network, realizes dynamic and flexible calculation capability scheduling and deployment, and improves a resource utilization efficiency of a terminal in an idle state.

In some optional embodiments, the method further includes: acquiring calculation capability registration information of at least one second UE from a first network element.

In some embodiments of the present disclosure, this step may be performed between step 201 and step 202. The first network element may be a calculation capability storage network element (see a “storage” network element in FIG. 1). The e first network element may store information about a calculation capability node that provides the calculation capability service. In the present disclosure, the UE may perform calculation capability deployment collaborative with the core network. The first network element may store information about a UE that can provide the calculation capability service, and may also store information about other calculation capability nodes, such as information about the calculation capability node in the core network or information about a third-party calculation capability node outside the core network, which is not limited by the present disclosure. The calculation service module may coordinate deployment of a calculation task requested by the first UE by acquiring information from the first network element.

In some possible implementations, the first network element may be a network element specifically used to store the information about the calculation capability node, or may be a general or shared storage network element in the core network, used to store the information about the calculation capability node and other information, which is not limited in this disclosure.

In some possible implementations, the first network element may also be deployed outside the core network, and the information stored therein may perform data exchange with the core network through the NEF network element, which is not limited in the present disclosure.

In some optional embodiments, the second UE may be all or part of the UEs stored in the first network element that can provide the collaborative calculation service for the core network. The calculation capability information such as the size of the calculation capability and the type of the calculation capability that the UE can provide is registered in the first network element, and the calculation service module may obtain the calculation capability registration information of all or part of the second UEs stored in the first network element to determine one or more UEs that perform the calculation capability service.

In some embodiments of the present disclosure, the calculation capability registration information may be information about the calculation capability of the UE registered or registered by the UE in the core network (specifically, for example, the first network element).

In some embodiments of the present disclosure, the calculation capability registration information at least includes an identifier, a calculation capability type, or an available calculation capability size of each second UE.

In some embodiments of the present disclosure, the calculation service module receives calculation capability registration information of one or more second UEs that can provide the calculation capability service sent by a calculation capability storage network element to determine whether there is at least one third UE that meets the calculation capability requirement in the service request among the second UEs.

In some optional embodiments, the method further includes: determining, based on the calculation capability registration information of the at least one second UE, the at least one third UE that performs the calculation capability service among the at least one second UE.

In some embodiments of the present disclosure, this step may be performed between step 201 and step 202. In response to receiving the service request, the calculation service module may perform service sensing on the service request, and the service sensing is performing an intelligent evaluation on requirements, such as, the size of the calculation capability and the type of the calculation capability, required by the request, according to different types of requests, such as voice processing or image processing.

In some embodiments of the present disclosure, the calculation service module determines the at least one third UE that performs the calculation capability service from the at least one second UE based on the service sensing and the calculation capability information of each UE registered in the first network element.

In the present disclosure, the calculation service module may use a predefined algorithm to determine the at least one third UE, and the type of the algorithm is not limited in the present disclosure.

FIG. 3 is a flowchart illustrating a method for calling a calculation capability service according to an embodiment of the present disclosure. The method is performed by a calculation service module. As illustrated in FIG. 3, the method for calling a calculation capability service may include the following steps.

At step 301, a service request sent by a first UE is received.

In some embodiments of the present disclosure, the service request is used to request to call a calculation capability service.

In the present disclosure, the principle of step 301 is the same as the principle of step 201 in the embodiment shown in FIG. 2, and reference may be made to the relevant description of FIG. 2, and is not repeated here.

At step 302, an acquisition request is sent to the first network element.

The acquisition request is used to request calculation capability registration information of a UE.

In some embodiments of the present disclosure, the acquisition request may include a size of a calculation capability required to perform the calculation capability service, so as to request the first network element to find calculation capability registration information of a UE that can provide this size of calculation capability. Or, the acquisition request may include a type of a calculation capability, to request the first network element to find calculation capability registration information of a UE that can provide this type of calculation capability. Or, the acquisition request may include a status of the UE, to request the first network element to find calculation capability registration information of a UE in a specific state (for example, a UE in an idle state).

In some embodiments of the present disclosure, the calculation capability storage network element stores calculation capability registration information of one or more UEs (i.e., the second UE mentioned above), and calculation capability resources of respective UEs may be the same or different, that is, the respective UEs can provide the same or different sizes of calculation capabilities and types of calculation capabilities.

In some embodiments of the present disclosure, the first network element may further store a status of each UE, such as an idle state or an occupied state. The status of a UE that has been called is stored as the occupied state in the first network element, and this UE may not be called again before completing the current calculation capability service. The status of a UE that has not been called is stored as an idle state in the calculation capability storage network element, and this UE may provide the calculation capability service for the above service.

In some possible implementations, the first network element may further store a remaining calculation capability of each UE. For example, in a case where a total calculation capability of a certain UE is X, the UE is called to perform a calculation capability service A, and the calculation capability required to perform the calculation capability service A is Y, the first network element may store the remaining calculation capability X-Y of the UE, and in a case where a calculation service B is required to be performed and a size of a calculation capability required for the calculation service B is less than X-Y, the calculation service module may call the UE to perform the calculation service B.

At step 303, the calculation capability registration information of the at least one second UE sent by the first network element is received.

In some embodiments of the present disclosure, the calculation capability registration information may be information about the UE calculation capability created or registered by the UE in the core network (specifically, for example, the first network element).

In some embodiments of the present disclosure, the calculation capability registration information includes at least an identifier, a calculation capability type, or an available calculation capability size of each second UE.

In some embodiments of the present disclosure, the calculation service module receives the calculation capability registration information of one or more second UEs capable of providing the calculation capability service that is sent by a calculation capability storage network element, and determines whether there is at least one third UE that meets the calculation capability requirement in the service request among the second UEs based on service sensing.

At step 304, presence or absence of the at least one third UE is determined from the at least one second UE.

In an embodiment of the present disclosure, a total calculation capability resource of the at least one third UE meets a calculation capability requirement in the service request.

In an embodiment of the present disclosure, the calculation service module may determine, based on the service request and the calculation capability registration information of the at least one second UE, presence or absence of the third UE among the second UE using a resource matching algorithm. For example, the calculation service module may extract relevant information in the service request through service sensing, such as the identifier of the first UE, an identifier of the calculation capability service, a type of the calculation capability service, the calculation capability requirement, etc., to determine the size of the calculation capability, the type size of the calculation capability, and other information required for a calculation task requested by the first UE to be performed, and determine whether there is a third UE that can provide the calculation capability service through the calculation capability registration information of the second UE acquired from the first network element, that is, determine whether there is at least one third UE that meets the calculation capability requirement in the service request.

For example, if a calculation amount of a calculation task required by the first UE to be performed is small, a calculation capability required is also small, in this case, a single third UE may complete the calculation service alone. If the calculation amount of the calculation task required by the first UE to be performed is large, the calculation capability required is also large, in this case, a single third UE may not be able to fully complete the calculation service, and distributed calculation support from a plurality of third UEs is required. The calculation service module measures resource utilization through a specific algorithm to determine one or more third UEs to provide an optimal calculation deployment decision.

At step 305, absence of the at least one third UE among at least one second UE is determined, and feedback information is sent to the first UE.

The feedback information is used to notify the first UE of a calling failure. For example, the feedback information may carry a calling failure field, which indicates that there is currently no available calculation capability node to provide the calculation capability service, and this times of calling fails, and the first UE may abandon calling of the calculation capability service.

Or, the feedback information may be used to notify the first UE of waiting for a UE that meets a calculation capability requirement the first UE. For example, the feedback information may carry a waiting field, which indicates that there is currently no available calculation capability node to provide the calculation capability service, and the first UE may wait for other calculation capability nodes that can provide calculation capability service.

In an embodiment of the present disclosure, if the calculation service module determines that there is no third UE that can provide calculation capability service to the first UE among the second UEs, that is, there is no third UE that meets a calculation capability requirement of any of split sub-services of the second UE, then the calculation service module cannot schedule the third UE for the calculation task requested by the first UE. The calculation service module may send the feedback information to the first UE to notify the first UE of the calling failed, and the first UE may decide whether to abandon the current calculation task, or wait, or change to other calculation tasks.

In some optional embodiments, the calculation service module may also directly notify the first UE to wait through the feedback information. The first UE may not abandon the current calculation task, but wait for a third UE that can provide the service to the first UE and meet the calculation capability requirement of the current calculation task.

At step 306, presence of the at least one third UE among at least one second UE is determined and indication information of performing the calculation capability service is sent to the at least one third UE.

The indication information includes data information and/or a task requirement required to perform the calculation capability service.

In an embodiment of the present disclosure, in a case where the calculation service module determines that there is at least one third UE that can provide the calculation capability service to the first UE among the second UEs, the calculation service module may allocate split sub-services to the third UEs respectively, that is, send indication information to the third UEs respectively to instruct the third UEs to perform the calculation capability service.

The indication information carries the data information and/or the task requirement required to perform the calculation capability service. For example, the calculation capability service requested by the first UE is performing image processing on 100 pictures. The calculation service module may split the task, for example, into 5 subtasks, and process 20 images for each subtask, and determine the third UEs that perform respective sub-services in the second UEs, for example, 5 third UEs. The calculation service module may send the 20 images and a task requirement for image processing to each third UE, so that each third UE performs the calculation and processing task for the received images.

The calculation service module determines that there are a plurality of UEs that meet the calculation task requirement in the second UEs, and the plurality of UEs are called as fourth UEs. The calculation service module may further select one or more third UEs from the plurality of fourth UEs. The selection may be based on one or more dimensions, such as a utilization and/or a calculation efficiency and/or a calculation capability.

In an embodiment of the present disclosure, the indication information of the calculation capability service may be sent to one or more third UEs that can provide a total calculation capability greater than and closest to a calculation capability required by the first UE to request the calculation service, so as to avoid wasting of resources of the terminal. For example, the calculation resources service requested by the first UE is performing image processing on 500 images. In this case, there are two third UEs in an idle state in the second UEs, one of which can perform the image processing on 550 images (a utilization rate is 5/5.5) and the other of which can perform the image processing on 600 images (a utilization rate is 5/6). In this time, the indication information of the calculation capability service may be sent to the third UE that can perform the image processing on 550 images to reasonably utilize the resource of the terminal.

Similarly, in an embodiment of the present disclosure, taking into account calculation efficiencies and/or calculation capabilities of different UEs, a UE with a high calculation efficiency and/or a high calculation capability may be selected as the third UE. For example, the calculation capability service requested by the first UE is performing the image processing on 500 images. In this case, there are two third UEs in the idle state among the second UEs, one of which has a calculation capability of 1.5 TFlops and the other of which has a calculation capability of 2 TFlops. The UE with the calculation capability of 2 TFlops is selected as the third UE. For example, the calculation capability service requested by the first UE is performing the image processing on 500 images. In this case, there are two third UEs in the idle state among the second UE, one of which has a calculation efficiency of 0.1568 (unit calculation capability/carbon emissions) and the other of which has a calculation efficiency of 0.4325 (unit calculation capability/carbon emissions). The UE with the calculation efficiency of 0.4325 is selected as the third UE.

In summary, according to the method for calling the calculation capability service provided by the present disclosure, the method is performed by the calculation service module, including: receiving the service request sent by a UE through a user plane connection; sending the calculation capability registration information acquisition request to the first network element; receiving the calculation capability registration information of the at least one second UE sent by the first network element; determining, based on the service request and the calculation capability registration information of the at least one second UE, whether there is at least one third UE from at least one second UE using the resource matching algorithm, in which, the total calculation capability resource of at least one third UE meets the calculation capability requirement in the service request; determining absence of the at least one third UE in at least one second UE, and sending the feedback information to the first UE; determining presence of the at least one third UE in at least one second UE, and sending the indication information of performing the calculation capability service to the at least one third UE. The solution of the present disclosure realizes that the calculation service module matches the calculation capability resource information through service sensing, allocates the required third UE based on the service request, and then enables the first UE to send the indication information to the allocated third UE, such that the calculation service module efficiently and reasonably calls the third UE, which realizes flexible and accurate calculation capability scheduling of the UE, and improves a network utilization and a communication efficiency.

FIG. 4 is a flowchart illustrating a method for calling a calculation capability service according to an embodiment of the present disclosure. The method is performed by a calculation service module. Based on the embodiment shown in FIG. 3, the method for calling a calculation capability service may include the following steps.

At step 401, a service request sent by a first UE is received.

In some embodiments of the present disclosure, the service request is used to request to call a calculation capability service.

At step 402, the capability registration information of at least one second UE is acquired from a first network element.

At step 403, presence or absence of the third UE among the second UE is determined, based on the service request and the calculation capability registration information of the at least one second UE, using a resource matching algorithm. A total calculation capability resource of the at least one third UE meets a calculation capability requirement in the service request.

In the present disclosure, the principle of steps 401 to 403 is the same as the principle of relevant steps in the embodiments shown in FIG. 2-FIG. 3 above, and reference may be made to the relevant description of the above embodiments, and is not repeated here.

At step 404, presence of the at least one third UE among at least one second UE is determined and indication information of performing the calculation capability service is sent to the at least one third UE.

In an embodiment of the present disclosure, in a case where the calculation service module determines that there is at least one third UE that can provide the calculation capability service to the first UE among the second UEs, the calculation service module may allocate split sub-services to the third UEs respectively, that is, send the indication information to the determined third UEs respectively to instruct the respective third UEs to perform the calculation capability service.

In an optional embodiment, the step 404 may include: sending the indication information to a second network element.

The indication information is used to indicate the second network element to send data information and/or a task requirement required to perform the calculation capability service to the at least one third UE.

In some embodiments of the present disclosure, the second network element may be an AMF network element. Specifically, the calculation capability service may be deployed on a plurality of calculation capability nodes (for example, when the calculation capability service is collaboratively executed by a UE in the present disclosure, the UE may be served as the calculation capability node), and the calculation service module may send the indication information to the AMF network element, and the indication message may also include an identifier of a third UE. The AMF receives the indication information and sends the indication message to the third UE to implement calling of the calculation service module on the third UE.

The indication information carries the data information and/or the task requirement required to perform the calculation capability service. For example, the calculation capability service requested by the first UE is performing image processing on 100 pictures. The calculation service module may split the task, for example, into 5 subtasks, and process 20 images for each subtask, and determine the third UEs that perform respective sub-services, for example, 5 third UEs. The calculation service module may send the 20 images and a task requirement for image processing to each third UE, so that each third UE performs the calculation and processing task for the received images.

At step 405, a calculation result fed back by the at least one third UE is received.

The calculation result is a result obtained by performing, by the at least one third UE, the calculation capability service based on the indication information.

In an embodiment of the present disclosure, the third UE performs task processing based on the data information and/or the task requirement provided by the received indication information, and the calculation service module may receive the calculation result obtained after one or more third UEs determined in the second UE complete the allocated calculation capability service.

At step 406, aggregation processing is performed on the calculation result to obtain an aggregation result.

In some embodiments of the present disclosure, a task division of each third UE may be different, and the calculation service module may divide the received calculation task into a plurality of steps, such as data cleaning, model training, etc. In an example, after completing the data cleaning, one of the third UEs returns cleaned data to the calculation service module, and the calculation service module then sends the cleaned data to another third UE for model training. After training is completed, the data is returned to the calculation service module. The calculation service module may aggregate the calculation results of the respective third UEs to obtain the aggregated result.

In some embodiments of the present disclosure, the task division of each third UE may also be the same, and each third UE may return the calculation result to the calculation service module for aggregation. After completing the aggregation processing of the calculation results of the respective third UEs, and the aggregated result may be obtained. In this case, compared with a case where a respective third UE has a different division, the calculation service module can aggregate and package the calculation results returned by respective modules, without a need to perform secondary processing on each calculation result.

At step 407, the aggregation result is sent to the first UE.

In some embodiments of the present disclosure, the calculation service module may feed back the aggregation result to the first UE through a user plane connection. The first UE establishes a connection with a core network through a user plane. When the calculation service module receives the aggregation result, it indicates that the calculation service module completes a calculation capability calling service, and sends the above aggregation result to the first UE through the user plane connection established between the calculation service module and the terminal. Different from establishing a connection through a control plane, the connection through the user plane may directly establish a connection from the user plane to each third UE that provides the calculation capability, and may also upload data or parameters, while the control plane cannot send data packets by default.

It should be understood that the above steps 406-407 may be optional steps. In other words, the calculation service module may directly send each calculation result to the first UE without performing the aggregation processing, which is not limited in the present disclosure.

At step 408, confirmation information sent by the first UE is received.

In some embodiments of the present disclosure, the first UE sends the confirmation information to the calculation service module based on the received aggregation result sent by the calculation service module, and the calculation service module receives the confirmation information. In some embodiments, in a case where the aggregation result does not meet a predefined requirement, the first UE may request to call the calculation capability service again or make modifications in other ways, which is not limited by the present disclosure.

In some embodiments, the method further includes: sending a status update request to the first network element.

In an embodiment of the present disclosure, the status update request may be used to request to update a status of a UE stored in the first network element. The status may be an occupied state or an idle state.

It should be understood that this step may be an optional step, and the present disclosure does not limit an order of execution. In a possible implementation, this step may be performed after step 404 and before step 405, that is, in a case where the calculation service module sends the calculation task to the third UE, the calculation service module may send the status update request to the first network element to change the state of the third UE from the idle state to the occupied state. In another possible implementation, this step may be performed after step 405, that is, in a case where the calculation service module receives the calculation result fed back by the third UE, the calculation service module may send the status update request to the first network element to change the state of the third UE from the occupied state to the idle state. This is not limited in the present disclosure.

In some embodiments of the present disclosure, the status update request may be used to request a remaining calculation capability of the third UE. The remaining calculation capability of each UE can also be stored in the first network element. For example, a total calculation capability of a certain UE is X, and the UE is called to perform a calculation service A. A calculation capability required to perform the calculation service A is Y. The first network element may store the remaining calculation capability X-Y of the UE, and in a case where a calculation service B needs to be performed and the calculation capability required for the calculation service B is less than X-Y, the calculation service module may call the UE to perform the calculation service B.

In some embodiments of the present disclosure, the calculation service module completes service segmentation and allocation, sends sub-services to the third UEs, and may change a calculation capability state of the called third UEs by sending the status update request to the first network element, that is, the called third UEs is changed from the idle state to the occupied state.

In some embodiments of the present disclosure, the calculation service module receives the calculation result fed back by the third UE, indicating that the calculation capability service of the third UE ends, sends the status update request to the first network element, changes the calculation status of the third UE, that is, the third UE that has completed the calculation capability service is changed from the occupied state to the idle state.

In summary, according to the method for calling the calculation capability service provided by the present disclosure, the method is performed the calculation service module, including: receiving the service request sent by the first UE, acquiring the calculation capability registration information of the at least one second UE from the first network element, and determining, based on the service request and the calculation capability registration information of the at least one second UE, the presence or absence of the third UE among the second UE using the resource matching algorithm, in which, the total calculation capability resource of the at least one third UE meets the calculation capability requirement in the service request, determining presence of the at least one third UE among at least one second UE, sending the indication information of performing the calculation capability service to the at least one third UE, receiving the calculation result fed back by at least one third UE, aggregating the calculation result to obtain the aggregated result, sending the aggregated result to the first UE, receiving the confirmation information sent by the first UE, sending the status update request to the first network element, and sending the indication request to the second network element. Therefore, it may be realized that the calculation capability service module can reasonably call the UE side to perform the calculation capability service, a task pressure carried by the network may be effectively reduced, and a processing speed of the calculation capability task may be improved.

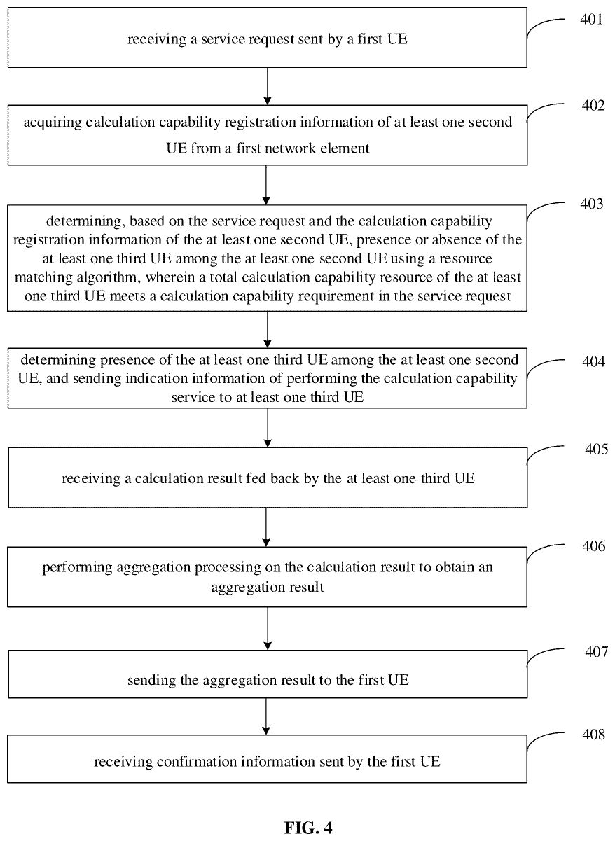

FIG. 5 is a flowchart illustrating a method for calling a calculation capability service according to an embodiment of the present disclosure. The method is performed by a first UE. As illustrated in in FIG. 5, the method for calling a calculation capability service may include the following step.

At step 501, a service request is sent to a calculation service module.

The service request is used to request to call a calculation capability service.

In some embodiments of the present disclosure, the service request includes at least one of: an identifier of the first UE; an identifier of the calculation capability service; a type of the calculation capability service; a calculation capability requirement; or a network bandwidth.

In some optional embodiments of the present disclosure, an identifier of the first UE may be a subscription permanent identifier (SUPI), or other identifiers that can uniquely identify the UE, which is not limited in the present disclosure. An identifier of the calculation capability (Cal Service ID) may be a code that marks a calculation capability service that can be called. A type of the calculation capability service (Cal Service Type) may be a code or a field that marks the type of the calculation capability service that can be called. The calculation capability requirement is a size of a calculation capability requirement of the UE for a current calculation task to be performed. The network bandwidth may be a downlink network bandwidth, such that the network device returns a data packet of a calculation result that meets the bandwidth requirement to the UE.

In some optional embodiments of the present disclosure, the user plane connection between the first UE and the core network may be established in the following manner. In a case where the SMF network element receives a service calling request, it means that the terminal currently requests to call the service. The SMF network element may establish a connection with the first network element (an network element that provides a service requested by the terminal), such that the SMF network element subsequently interacts with the first network element to establish the user plane connection between the first network element and the terminal, thereby enabling the first network element to communicate with the terminal through the user plane to provide the terminal with the service requested by the terminal. It should be understood that the present disclosure does not limit the method for establishing the user plane connection, and user plane connections established in other possible manner all fall within the scope of the present disclosure.

In summary, according to the method for calling calculation capability service provided by the present disclosure, the method is performed by the first UE, including: sending the service request to the calculation service module, in which, the service request is used to request to call the calculation capability service. Thus, the first UE is connected to the calculation service module, providing a basis for the first UE to successfully call the calculation capability service of the core network.

FIG. 6 is a flowchart illustrating a method for calling a calculation capability service according to an embodiment of the present disclosure. The method is performed by a first UE. As illustrated in in FIG. 6, after performing step 501 above, the method for calling a calculation capability service may include the following steps.

At step 601, an aggregation result sent by a calculation service module is received.

The aggregation result is a result obtained by performing, by the calculation service module, aggregation processing on a calculation result of the at least one third UE.

In some embodiments of the present disclosure, the first UE may receive the aggregated result sent by the calculation service module to obtain the result of this time of calculation service calling.

In some embodiments of the present disclosure, the first UE may receive various calculation results sent by the calculation service module without the aggregation processing to obtain the result of this time of calculation service calling.

At step 602, confirmation information is sent to the calculation service module.

In some embodiments of the present disclosure, the first UE receives the calculation result of the calculation service module and sends the confirmation message to confirm that the first UE has received the calculation capability calling service.

To summarize, according to the method for calling calculation capability service provided by the present invention, the method is performed by the first UE, including: receiving the aggregation result sent by the calculation service module, in which the aggregation result is the result obtained by performing, by the calculation service module, aggregation processing on a calculation result of the at least one third UE, and sending the confirmation information to the calculation service module, so that the UE may receive a calling result of the calculation capability service timely and accurately, and feedback the received calculation capability service, so as to timely change the calculation capability status of the third UE, thus improving a resource utilization efficiency of the terminal in an idle state.

In some embodiments of the present disclosure, the first UE may receive feedback information sent by the calculation service module, and the feedback information is used to notify the first UE of a calling failure and/or waiting for a UE that meets a calculation capability requirement. In response to the feedback information, the first UE determines whether to abandon a current calculation task, or wait, or change to other calculation tasks, or in response to the feedback information, waits for a third UE that can provide a service to the first UE and meets the calculation capability requirement of the current calculation task.

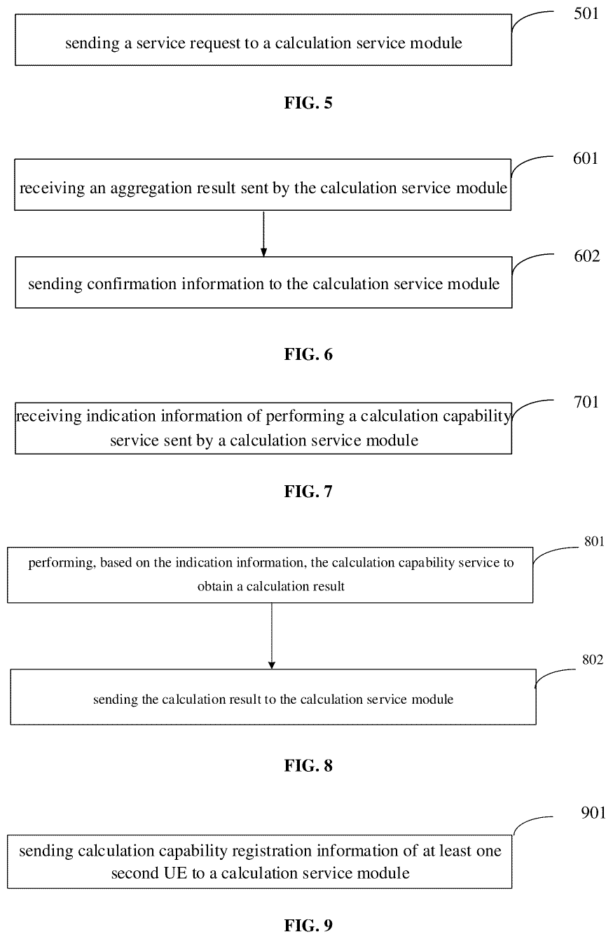

FIG. 7 is a flowchart illustrating a method for calling a calculation capability service according to an embodiment of the present disclosure. The method is performed by a third UE. As illustrated in in FIG. 7, the method for calling a calculation capability service may include the following step.

At step 701: indication information of performing a calculation capability service sent by a calculation service module is received.

In some embodiments of the present disclosure, the indication information includes data information and/or a task requirement required to perform the calculation capability service.

In some embodiments of the present disclosure, the third UE receives the indication information of performing the calculation capability service sent by the calculation service module. Through deployment of the calculation service module, each third UE may perform a corresponding calculation task to provide the calculation capability service.

In summary, according to the method for calling a calculation capability service provided by the present disclosure, the method is performed by the third UE, including: receiving the indication information of performing the calculation capability service sent by the calculation service module. Thus, the third UE perform an allocated calculation task according to the indication information.

FIG. 8 is a flowchart illustrating a method for calling a calculation capability service according to an embodiment of the present disclosure. The method is performed by a third UE. As illustrated in in FIG. 8, after executing step 701 above, the method for calling a calculation capability service may include the following steps.

At step 801, the calculation capability service is performed based on the indication information to obtain a calculation result.

In some embodiments of the present disclosure, the third UE performs, based on the indication information, the calculation capability service such as data cleaning, model training, etc. to obtain the calculation result. Different third UEs may perform different calculation tasks or the same calculation task, which depends on splitting and deployment of the calculation task requested by the first UE by the calculation service module.

At step 802, the calculation result is sent to the calculation service module.

In some embodiments of the present disclosure, the third UE sends the above calculation result to the calculation service module, and the calculation service module sends the result to the first UE.

In addition, the calculation service module may directly feed back the calculation result of each third UE to the first UE, or may package and summarize the calculation results of respective third UEs and then feed back the summarized result to the first UE, or may perform secondary aggregation processing on the calculation results of each third UE and then feed back the aggregation result to the first UE, which is not limited by the present disclosure.

To summarize, according to the method for calling the calculation capability service provided in the present disclosure, the method is performed by the third UE and includes: performing, based on the indication information, the calculation capability service to obtain the calculation result, and sending the calculation result to the calculation service module, thereby realizing sending of the calculation result of the third UE to the calculation service module.

FIG. 9 is a flowchart illustrating a method for calling a calculation capability service according to an embodiment of the present disclosure. The method is performed by a first network element. As illustrated in in FIG. 9, the method for calling a calculation capability service may include the following step.

At step 901, calculation capability registration information of at least one second UE is sent to a calculation service module.

The calculation capability registration information of the at least one second UE is used to assist the calculation service module in determining at least one third UE that performs a calculation capability service.

In some embodiments of the present disclosure, the first network element may be a calculation capability storage network element (see a “storage” network element in FIG. 1). The first network element may store information about a calculation capability node that provides the calculation capability service. In the present disclosure, the UE may perform calculation capability deployment collaborative with the core network. The first network element may store information about a UE that can provide the calculation capability service, and may also store information about other calculation capability nodes, such as information about the calculation capability node in the core network or information about a third-party calculation capability node outside the core network, which is not limited by the present disclosure. The calculation service module may coordinate deployment of a calculation task requested by the first UE by acquiring information from the first network element.

In some possible implementations, the first network element may be a network element specifically used to store the information about the calculation capability node, or may be a general or shared storage network element in the core network, used to store the information about the calculation capability node and other information, which is not limited in this disclosure.

In some possible implementations, the first network element may also be deployed outside the core network, and the information stored therein may perform data exchange with the core network through the NEF network element, which is not limited in the present disclosure.

In some embodiments of the present disclosure, the first network element sends the stored calculation capability registration information of the at least one second UE to the calculation service module to help the calculation service module select a suitable third UE for deployment of the calculation capability service for the service request based on a service sensing result and the received calculation capability resource information of the second UE.

To summarize, according to the method for calling the calculation capability service provided in the present invention, the method is executed by the first network element, and includes: sending the calculation capability registration information of the at least one second UE to the calculation service module, so that the first network element sends the calculation capability information of the second UE to the calculation service module to help the calculation service module complete service allocation.

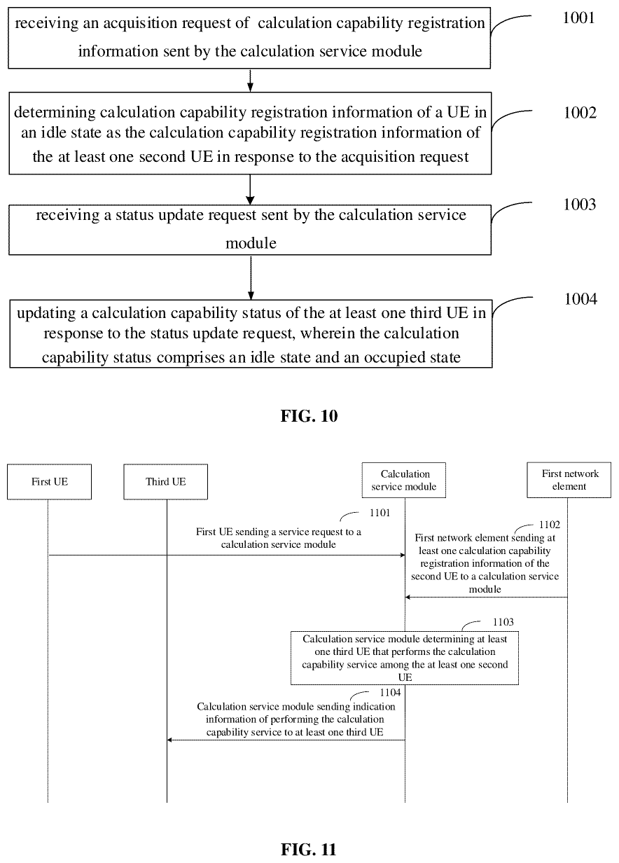

FIG. 10 is a flowchart illustrating a method for calling a calculation capability service according to an embodiment of the present disclosure. The method is performed by a first network element. As illustrated in in FIG. 10, the method for calling a calculation capability service may include the following steps.

At step 1001, an acquisition request of calculation capability registration information sent by a calculation service module is received.

In some embodiments of the present disclosure, the first network element receives the acquisition request of calculation capability registration information sent by the calculation service module to determine a third UE that can provide the calculation capability service.

At step 1002, in response to the acquisition request of calculation capability registration information, calculation capability registration information of the UE in an idle state is determined as calculation capability registration information of at least one second UE.

The calculation capability registration information includes at least an identifier, a calculation capability type, and an available calculation capability of each second UE.

In some examples of the present disclosure, the first network element determines the calculation capability registration information of the UE in the idle state as the calculation capability registration information of the at least one second UE, and a total calculation capability that can be provided by the second UE meets a calculation capability required by the service request of the first UE, and can provide the second UE with a calculation capability close to the required calculation capability requirement.

At step 1003, a status update request sent by the calculation service module is received.

In some embodiments of the present disclosure, the first network element receives the status update request sent by the calculation service module after issuing a calculation capability task to the third UE, and the status update request requests to update the state of the called third UE from the idle state to an occupied state, which indicates that the third UE is providing the calculation capability service and may not be called to serve other calculation capability services during this period.

In some embodiments of the present disclosure, the first network element receives the status update request sent by the calculation service module after receiving confirmation information sent by the first UE, and the status update request requests to update the state of the called third UE from the occupied state to the idle state, which indicates that the third UE ends the calculation capability service and can provide calculation capability support for other calculation capability services.

At step 1004, in response to the status update request, the calculation capability status of at least one third UE is updated. The calculation capability status includes an idle state and an occupied state.

In some embodiments of the present disclosure, the first network element receives the status update request sent by the calculation service module, and changes the state of the called third UE from the idle state to the occupied state, or changes the state of the third UE that has completed the calculation capability service from the occupied state to the idle state. Thus, the state of the third UE may be changed in time, and a resource utilization efficiency of the terminal in the idle state may be improved.

To summarize, according to the method for calling the calculation capability service provided by the present disclosure, the method is performed by the first network element and includes: receiving the acquisition request of calculation capability registration information sent by the calculation service module, and in response to the acquisition request of calculation capability registration information, determining the calculation capability registration information of the UE in the idle state as the calculation capability registration information of the at least one second UE, receiving the status update request sent by the calculation service module, and in response to the status update request, updating the calculation capability status of the at least one third UE, the calculation capability status including the idle state and the occupied state. With timely changing the state of the third UE, the resource utilization efficiency of the terminal in the idle state is improved, and a task pressure carried by the network is reduced.

FIG. 11 is a flowchart illustrating an interactive method for calling a calculation capability service according to an embodiment of the present disclosure. The method may be performed by a communication system, and the communication system includes a first UE, a third UE, a calculation service module, and a first network element. As illustrated in FIG. 11, the interactive method may include the following steps.

1101, The first UE sends a service request to a calculation service module.

In some embodiments of the present disclosure, the service request is used to request to call a calculation capability service.

1102. The first network element sends calculation capability registration information of at least one second UE to the calculation service module.

In some embodiments of the present disclosure, the calculation capability registration information of the at least one second UE is used to assist the calculation service module in determining at least one third UE that performs the calculation capability service.

1103. The calculation service module determines the at least one third UE that performs the calculation capability service among at least one second UE.

1104. The calculation service module sends indication information of performing the calculation capability service to the at least one third UE.

The principles of the above steps 1101-1104 are the same as the principles of the various steps in the embodiment shown in the above FIGS. 2-10. Reference may be made to the relevant description of FIGS. 2-10 and details may not be repeated here.

To summarize, according to the method for calling the calculation capability service provided by the present disclosure, through interaction between the first UE, the third UE, the calculation service module and the first network element, the first UE sends the service request to the calculation service module, in which, the service request is used to request to call the calculation capability service, the first network element sends the calculation capability registration information of the at least one second UE to the calculation service module, and the calculation capability registration information of the at least one second UE is used to assist the calculation service module in determining the at least one third UE that performs the calculation capability service, and the calculation service module determines the at least one third UE that performs the calculation capability service from the at least one second UE, and the calculation service module sends the indication information for performing the calculation capability service to the at least one third UE. Thus, a complete calculation capability service workflow in the core network is realized, so that the terminal may provide the calculation capability service collaborative with the network, a task pressure carried by the network may be reduced, and a resource utilization efficiency of a terminal in an idle state may be improved.

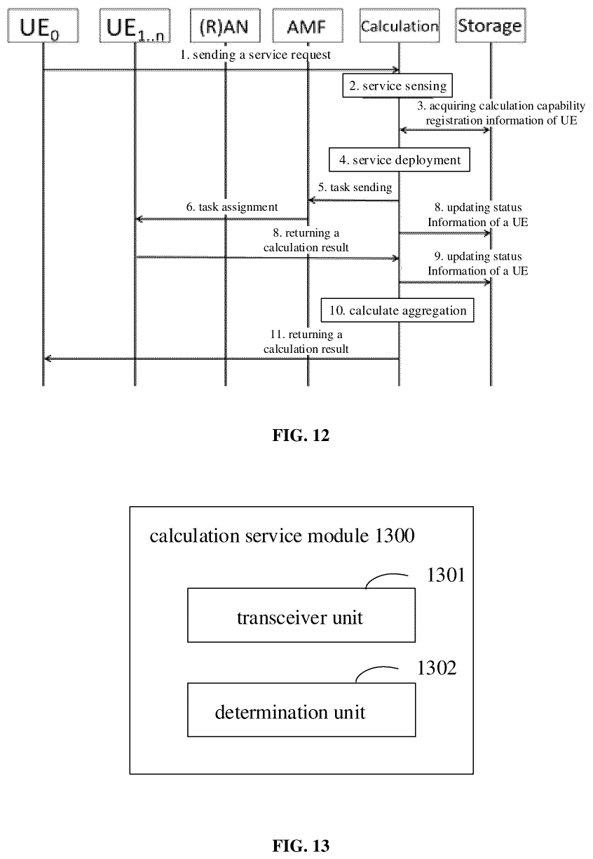

As an example, a calculation capability service call workflow may be shown in FIG. 12.

The first UE sends a service request to a calculation service module in a core network, and the request information includes: a UE identifier, a calculation capability service identifier (Cal Service ID), a calculation capability service type (Cal Service Type), a calculation capability requirement, a network bandwidth, etc., as illustrated in step 1 of FIG. 12.

The calculation service module receives service request information and analyzes and translates the service request information to complete service sensing, as illustrated in step 2 of FIG. 12.

Based on a service sensing result, if the calculation service module needs to call a UE-side calculation capability to coordinate the network to complete the service, the calculation service module sends an acquisition request of calculation capability registration information of the second UE to a first network element, namely a Storage network element, and the Storage network element returns a result, as illustrated in step 3 of FIG. 12.

The calculation service module performs calculation capability service deployment according to the calculation capability registration information received of the second UE, as illustrated in step 4 of FIG. 12.

The calculation service module allocates a calculation capability task and sends data, a task requirement and information of an allocated third UE to an access and mobility management function (AMF) network element, as illustrated in step 5 of FIG. 12.

The calculation capability service may be deployed on a plurality of calculation capability nodes (for example, when the calculation capability service is performed collaboratively by the UE in the present disclosure, the UE may be served as a calculation capability node), and the AMF sends corresponding data and task requirements to different third UEs, as illustrated in step 6 of FIG. 12.

The calculation service module sends updated status information of the third UE to the Storage network element, and adjusts the third UE assigned with the task to an occupied state, as illustrated in step 7 of FIG. 12.

Each third UE uploads a calculation result to the calculation service module, as illustrated in step 8 of FIG. 12.

The calculation service module sends the updated status information of the third UE to the Storage network element, and adjusts the third UE that completes the task to an idle state, as illustrated in step 9 of FIG. 12.

After receiving calculation results of all subtasks, the calculation service module performs aggregate calculation processing on the received calculation results, as illustrated n step 10 of FIG. 12.

The calculation service module returns a final calculation result to a first UE requesting a service through a user plane, as illustrated in step 11 of FIG. 12.

In the above embodiments of the disclosure, the methods according to the embodiments of the disclosure are described from the perspectives of the network device and the UE, respectively. In order to realize each of functions in the methods according to the above embodiments of the disclosure, the network device and the UE may include a hardware structure, a software module, and realize each of the above functions in a form of hardware structure, software module, or a combination of the hardware structure and the software module. A certain function of the above functions may be performed in a form of the hardware structure, the software module, or the combination of the hardware structure and the software module.

Corresponding to the method for calling a calculation capability service provided by the aforementioned embodiments, the disclosure also provides an apparatus for calling a calculation capability service. As the apparatus for calling a calculation capability service provided by embodiments of the present disclosure corresponds to the method for calling a calculation capability service provided by the aforementioned embodiments, implementations of the method for calling a calculation capability service are also applicable for the apparatus for calling a calculation capability service provided by this embodiment, and will not be described in detail in this embodiment.

FIG. 13 is a schematic diagram of a structure of a calculation service module 1300 provided in an embodiment of the present disclosure. The calculation service module is deployed in a core network.

As illustrated in FIG. 13, the apparatus 1300 includes a transceiver unit 1301, configured to receive a service request sent by a first UE, in which, the service request is used to request to call a calculation capability service; and a determination unit 1302, configured to determine, based on calculation capability registration information of at least one second UE, at least one third UE of performing the calculation capability service among the at least one second UE.

In some embodiments, the transceiver unit 1301 is further configured to acquire the calculation capability registration information of the at least one second UE from a first network element.

In some embodiments, the transceiver unit 1301 is further configured to send indication information of performing the calculation capability service to the at least one third UE.

In some embodiments, the determination unit 1302 is further configured to divide, according to different types of service requests, a calculation service requested by the first UE into one or more sub-services, that is, to split a distributed calculation service, send the indication information to at least one determined third UE based on the divided sub-services, and allocate a plurality of sub-services to one or more third UEs for calculation. A calculation capability that the third UE can provide is greater than and similar to a calculation capability required for the sub-service, and a total calculation capability of a plurality of third UEs may be greater than or equal to a calculation capability requirement of a calculation task requested by the first UE, so as to provide the first UE with a reasonable calculation capability service for the service. Therefore, waste of calculation capability resources may be avoided.

In summary, according to the calculation service module provided by the present disclosure, the calculation service module is deployed in the core network. The service request sent by the first UE is received, in which, the service request is used to request to call the calculation capability service. The indication information of performing the calculation capability service is sent to the at least one third UE, in which, the at least one third UE is the UE that meets the requirement corresponding to the calculation service. A connection between the third UE and the calculation service module can be established, thereby enabling the calculation service module to provide the calculation capability service requested by the first UE to the first UE through communication with the third UE, which realizes that the UE to provides the calculation capability service cooperative with the network.

In some embodiments of the present disclosure, the service request includes at least one of: an identifier of the first UE; an identifier of the calculation capability service; a type of the calculation capability service; a calculation capability requirement; or a network bandwidth.

In some embodiments of the present disclosure, the transceiver unit 1301 is further configured to send an acquisition request of calculation capability registration information to the first network element. The acquisition request of the calculation capability registration information is used to request calculation capability registration information of a UE in an idle state.

In some embodiments of the present disclosure, the transceiver unit 1301 is further configured to receive the calculation capability registration information of the at least one second UE sent by the first network element. The calculation capability registration information at least includes an identifier, a calculation capability type, or an available calculation capability size of each second UE.

In some embodiments of the present disclosure, the determination unit 1302 is further configured to determine, based on the service request and the calculation capability registration information of the at least one second UE, presence or absence of the at least one third UE among the at least one second UE using a resource matching algorithm. A total calculation capability resource of the at least one third UE meets a calculation capability requirement in the service request.

In some embodiments of the present disclosure, the determination unit 1302 is further configured to determine the absence of the at least one third UE among the at least one second UE.

In some embodiments of the present disclosure, the transceiver unit 1301 is further configured to send feedback information to the first UE. The feedback information is configured to notify the first UE of a calling failure and/or waiting for a UE that meets a calculation capability requirement.

In some embodiments of the present disclosure, the determination unit 1302 is further configured to determine the presence of the at least one third UE among the at least one second UE. The indication information includes data information and/or a task requirement required to perform the calculation capability service.

In some embodiments of the present disclosure, the transceiver unit 1301 is further configured to receive a calculation result fed back by the at least one third UE. The calculation result is a result obtained by performing, by the at least one third UE, the calculation capability service based on the indication information.

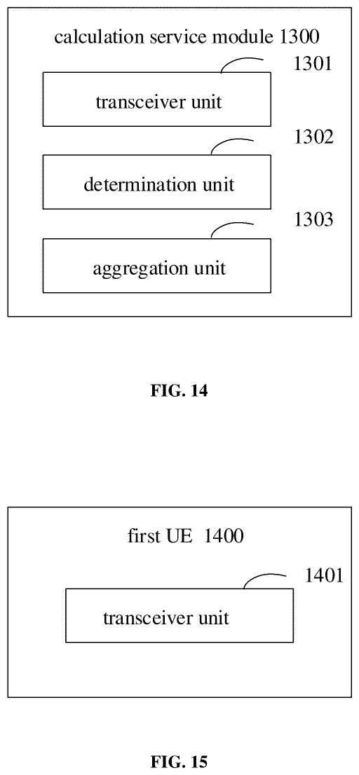

In some embodiments of the present disclosure, the apparatus further includes an aggregation unit 1303 as shown in FIG. 14. The aggregation unit 1303 is configured to perform aggregation processing on the calculation result to obtain an aggregation result.

In some embodiments of the present disclosure, the transceiver unit 1301 is configured to send the aggregation result to the first UE.

In some embodiments of the present disclosure, the transceiver unit 1301 is configured to receive confirmation information sent by the first UE.

In some embodiments of the present disclosure, the transceiver unit 1301 is configured to send a status update request to the first network element. The status update request is used to request the first network element to update a calculation capability status of the at least one third UE, and the calculation capability status includes an idle state and an occupied state.

In some embodiments of the present disclosure, the transceiver unit 1301 is configured to send the indication information to a second network element, and the indication information is used to indicate the UE to send data information and/or a task requirement required to perform the calculation capability service to the at least one third UE.

FIG. 15 is a schematic diagram of a structure of a first UE 1400 provided in an embodiment of the present disclosure.

As illustrated in FIG. 15, the apparatus 1400 includes a transceiver unit 1401, configured to send a service request to a calculation service module. The service request is used to request to call a calculation capability service.

In some embodiments of the present disclosure, the service request includes at least one of: an identifier of the first UE; an identifier of the calculation capability service; a type of the calculation capability service; a calculation capability requirement; or a network bandwidth.

In summary, according to the apparatus for calling a calculation capability service, the apparatus is configured in a first UE, the first UE is configured to send the service request to the calculation service module. The service request is used to request to call the calculation capability service, thus causing the first UE to connect with the calculation service module to call the calculation capability service.

In some embodiments of the present disclosure, the transceiver unit 1401 is configured to receive feedback information sent by the calculation service module. The feedback information is used to notify the first UE of a calling failure and/or waiting for a UE that meets a calculation capability requirement.

In some embodiments of the present disclosure, the transceiver unit 1401 is configured to receive an aggregation result sent by the calculation service module, and the aggregation result is a result obtained by performing, by the calculation service module, aggregation processing on a calculation result of the at least one third UE.

In some embodiments of the present disclosure, the transceiver unit 1401 is configured to send confirmation information to the calculation service module.

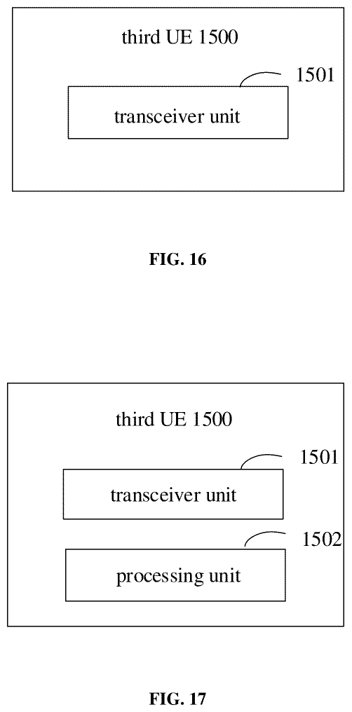

FIG. 16 is a schematic diagram of a structure of a third UE 1500 provided in an embodiment of the present disclosure.

As illustrated in FIG. 16, the apparatus 1500 includes a transceiver unit 1501, configured to receive indication information of performing a calculation capability service sent by a calculation service module.

In some embodiments of the present disclosure, the indication information includes data information and/or a task requirement required to perform the calculation capability service.

In summary, according to the apparatus for calling a calculation capability service, the apparatus is configured in a third UE, the third UE is configured to receive the indication information of performing the calculation capability service sent by the calculation service module. The indication information includes the data information and/or the task requirement required to perform the calculation capability service, thus enabling the third UE to perform the allocated calculation capability task based on the indication information.

In some embodiments of the present disclosure, the apparatus includes a processing unit 1502 as shown in FIG. 17. The processing unit 1502 is configure to perform a calculation capability service, to obtain a calculation result.

In some embodiments of the present disclosure, the transceiver unit 1501 is configured to send the calculation result to the calculation service module.

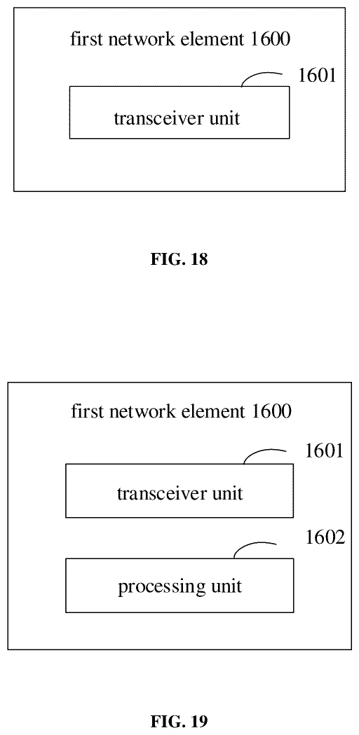

FIG. 18 is a schematic diagram of a structure of a first network element 1600 provided in an embodiment of the present disclosure.

As illustrated in FIG. 18, the apparatus 1600 includes a transceiver unit 1601, configured to send calculation capability registration information of at least one second UE to a calculation service module. The calculation capability registration information of the at least one second UE is used to assist the calculation service module in determining at least one third UE that performs a calculation capability service.

In summary, according to the apparatus for calling a calculation capability service, the apparatus is configured in a first network element, the first network element is configured to send the calculation capability registration information of the at least one second UE to the calculation service module. The calculation capability registration information of the at least one second UE is used to assist the calculation service module in determining the at least one third UE that performs the calculation capability service. Thus, the third UE that provides the calculation capability service is determined, realizing the third UE to provide the calculation capability service collaborative the network.

In some embodiments of the present disclosure, the transceiver unit 1601 is further configured to receive an acquisition request of calculation capability registration information sent by the calculation service module;

In some embodiments of the present disclosure, the apparatus further includes a processing unit 1602 as shown in FIG. 19. The processing unit 1602 is configured to determine calculation capability registration information of a UE in an idle state as the calculation capability registration information of the at least one second UE. The calculation capability registration information at least comprises an identifier, a calculation capability type, and an available calculation capability size of each second UE.

In some embodiments of the present disclosure, the transceiver unit 1601 is further configured to receive a status update request sent by the calculation service module.

In some embodiments of the present disclosure, the processing unit 1602 is configured to update a calculation capability status of the at least one third UE. The calculation capability status includes an idle state and an occupied state.

As illustrated in FIG. 20, FIG. 20 is a schematic diagram illustrating a communication device 1700 according to an embodiment of the disclosure. The communication device 1700 may be a network device, or a terminal, or a chip, a chip system, or a processor that supports the network device to implement the above method, or may be a chip, a chip system, or a processor that supports the terminal to implement the above methods. The apparatus may be used to implement the method as described in the above method embodiments. For details, reference may be made to the description in the above method embodiments.

The communication device 1700 may include one or more processors 1701. The processor 1701 may be a general-purpose processor or a dedicated processor, such as, a baseband processor or a central processor. The baseband processor is used for processing communication protocols and communication data. The central processor is used for controlling the communication device (e.g., a base station, a baseband chip, a terminal, a terminal chip, a DU, or a CU, etc.), executing a computer program, and processing data of the computer program.

In an example, the communication device 1700 may include one or more memories 1702 on which a computer program 1704 may be stored. The processor 1701 executes the computer program 1704 to cause the communication device 1700 to perform the method described in the above method embodiments. In an example, data may also be stored in the memory 1702. The communication device 1700 and the memory 1702 may be set separately or integrated together.

In an example, the communication device 1700 may also include a transceiver 1705 and an antenna 1706. The transceiver 1705 may be referred to as a transceiver unit, a transceiver element, or a transceiver circuit, for implementing the transceiver function. The transceiver 1705 may include a receiver and a transmitter. The receiver may be referred to as a receiver element or a receiving circuit, for implementing the receiving function. The transmitter may be referred to as a transmitter element or a transmitting circuit, for implementing the transmitting function.

In an example, the communication device 1700 may also include one or more interface circuits 1707. The interface circuits 1707 are used to receive code instructions and transmit them to the processor 1701. The processor 1701 runs the code instructions to cause the communication device 1700 to perform the method described in the method embodiments.

In an implementation, the processor 1701 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1701 may store a computer program 1703. When the processor 1701 executes the computer program 1703, the communication device 1700 is caused to perform the method as described in the above method embodiments. The above computer program may be solidified in the processor 1701, in such case, the processor 1701 may be implemented by hardware.

In an implementation, the communication device 1700 may include circuits. The circuits may implement the sending, receiving or communicating function in the preceding method embodiments. The processor and transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the above description of embodiments may be a network device or a terminal (such as a first terminal in the foregoing method embodiment), but the scope of the communication device described in the disclosure is not limited thereto, and the structure of the communication device may not be limited by FIG. 20. The communication device may be a stand-alone device or may be part of a large device. For example, the described communication device may be:
(1) a stand-alone IC, chip, chip system or subsystem;
(2) a set of ICs including one or more ICs, optionally, the set of ICs may also include storage components for storing data and computer programs;
(3) an ASIC, such as a modem;
(4) a module that may be embedded within other devices;
(5) a receiver, a terminal, a smart terminal, a cellular phone, a wireless device, a handheld machine, a mobile unit, an in-vehicle device, a network device, a cloud device, an artificial intelligence device, and the like; and
(6) others.

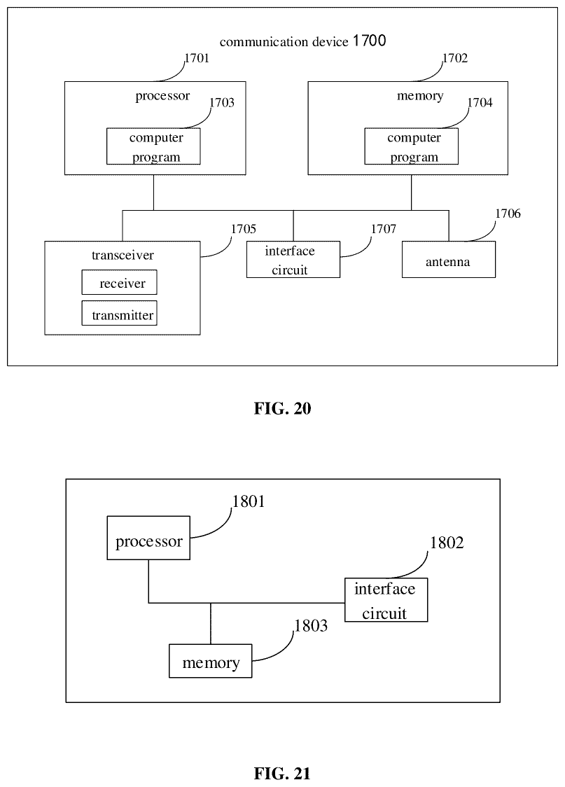

For a case where the communication device may be a chip or a chip system, please refer to the schematic diagram of a chip shown in FIG. 21. In FIG. 21, the chip includes a processor 1801 and an interface 1802. There may be one or more processors 1801, and there may be multiple interfaces 1802.

In an example, the chip further includes a memory 1803 used for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

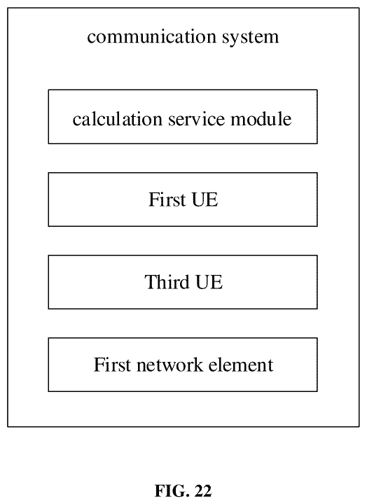

FIG. 22 is a schematic diagram illustrating a structure of a communication system according to an embodiment of the present disclosure. As illustrated in FIG. 22, the communication system includes: a calculation service module configured to perform the methods As illustrated in FIGS. 2 to 4 above; a first UE configured to perform the methods As illustrated in FIGS. 5 and 6 above; a third UE configured to perform the methods As illustrated in FIGS. 7 and 8 above; and a first network element configured to perform the methods As illustrated in FIGS. 9 and 10 above.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer programs on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device such as a server and a data center integrated by one or more usable mediums. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, pre-define, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above implementations are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the stated claims.

1. A method for calling a calculation capability service, performed by a network device, comprising:
receiving a service request sent by a first user equipment (UE), wherein the service request requests to call a calculation capability service; and
sending indication information of performing the calculation capability service to at least one third UE, wherein the at least one third UE is a UE that meets a requirement corresponding to the calculation service.

2. The method according to claim 1, wherein the service request comprises at least one of:
an identifier of the first UE;
an identifier of the calculation capability service;
a type of the calculation capability service;
a calculation capability requirement; or
a network bandwidth.

3. The method according to claim 1, further comprising:
acquiring calculation capability registration information of at least one second UE from a first network element;
determining, based on the calculation capability registration information of the at least one second UE, the at least one third UE among the at least one second UE.

4. The method according to claim 3, wherein acquiring the calculation capability registration information of the at least one second UE from the first network element comprises:
sending an acquisition request to the first network element, wherein the acquisition request requests calculation capability registration information of a UE;
receiving the calculation capability registration information of the at least one second UE sent by the first network element, wherein the calculation capability registration information at least comprises an identifier, a calculation capability type, or an available calculation capability size of each second UE.

5. The method according to claim 3, wherein the at least one second UE is a UE in an idle state.

6. The method according to claim 3, wherein determining, based on the calculation capability registration information of the at least one second UE, the at least one third UE among the at least one second UE comprises:
determining, based on the service request and the calculation capability registration information of the at least one second UE, the at least one third UE among the at least one second UE;
wherein a total calculation capability resource of the at least one third UE meets a calculation capability requirement in the service request.

7. The method according to claim 1, wherein the indication information comprises data information and/or a task requirement required to perform the calculation capability service.

8. The method according to claim 1, further comprising:
receiving a calculation result fed back by the at least one third UE;
wherein the calculation result is a result obtained by performing, by the at least one third UE, the calculation capability service based on the indication information.

9. The method according to claim 8, further comprising:
performing aggregation processing on the calculation result to obtain an aggregation result;
sending the aggregation result to the first UE;
receiving confirmation information sent by the first UE.

10. The method according to claim 3, further comprising:
sending a status update request to the first network element;
wherein the status update request requests the first network element to update a calculation capability status of the at least one third UE, and the calculation capability status comprises an idle state and an occupied state.

11. The method according to claim 3, further comprising:
sending a status update request to the first network element;
wherein the status update request requests a remaining calculation capability of the at least one third UE.

12. The method according to claim 1, wherein sending the indication information of performing the calculation capability service to the at least one third UE comprises:
sending the indication information to a second network element,
wherein the indication information indicates sending data information and/or a task requirement required to perform the calculation capability service to the at least one third UE.

13. The method according to claim 3, further comprising:
determining, based on the service request and the calculation capability registration information of the at least one second UE, absence of the at least one third UE among at least one second UE; and
sending feedback information to the first UE;
wherein the feedback information notifies the first UE of a calling failure and/or waiting for a UE that meets a calculation capability requirement.

14. A method for calling a calculation capability service, performed by a network device, comprising:
receiving a service request sent by a first user equipment (UE), wherein the service request requests to call a calculation capability service;
determining, based on the service request and calculation capability registration information of at least one second UE, at least one third UE among the at least one second UE; and
determining presence or absence of the at least one third UE, wherein the at least one third UE is a UE that meets a requirement corresponding to the calculation service.

15. The method according to claim 14, further comprising:
in a case of determining the absence of the at least one third UE, sending feedback information to the first UE;
wherein the feedback information is used to notify the first UE of a calling failure and/or waiting for a UE that meets a calculation capability requirement.

16. The method according to claim 14, further comprising:
in a case of determining the presence of the at least one third UE, sending indication information of performing the calculation capability service to the at least one third UE;
wherein the indication information comprises data information and/or a task requirement required to perform the calculation capability service.

17.-24. (canceled)

25. A method for calling a calculation capability service, performed by a first network element, comprising:
sending calculation capability registration information of at least one second user equipment (UE) to a calculation service module;
wherein the calculation capability registration information of the at least one second UE is used to assist the calculation service module in determining at least one third UE that performs a calculation capability service.

26. The method according to claim 25, further comprising:
receiving an acquisition request sent by the calculation service module;
determining calculation capability registration information of a UE in an idle state as the calculation capability registration information of the at least one second UE in response to the acquisition request;
wherein the calculation capability registration information at least comprises an identifier, a calculation capability type, and an available calculation capability size of each second UE.

27. The method according to claim 25, comprising:
receiving a status update request sent by the calculation service module;
updating a calculation capability status of the at least one third UE in response to the status update request, wherein the calculation capability status comprises an idle state and an occupied state.

28. The method according to claim 25, comprising:
receiving a status update request sent by the calculation service module;
updating a remaining calculation capability of the at least one third UE in response to the status update request.

29.-36. (canceled)
